(19) United States
(12) Patent Application Publication
(10) Pub. No.: US 2002/0106999 A1
(43) Pub. Date: Aug. 8, 2002

(54) Rescue system

(76) Inventor: Chung-Wei Wu, Taipei (TW)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 09/777,574

(22) Filed: Feb. 6, 2001

(51) Int. Cl. H04Q 7/20

(52) U.S. Cl. 455/404; 455/456; 455/427

(57) ABSTRACT

A method for establishing a rescue system by integrating a positioning system with a mobile phone is disclosed. The method includes steps of a) setting a database in the mobile phone, b) transmitting an emergency signal to the positioning system according to the database when the mobile phone receives an emergency command, c) identifying a location of a dispatcher when the emergency signal is received by the positioning system, and d) transmitting a rescue signal from the mobile phone to a rescue unit.

### FIELD OF THE INVENTION

The present invention relates to a method for establishing a rescue system, and more particularly to a method for establishing a rescue system by integrating a positioning system with a mobile phone.

### BACKGROUND OF THE INVENTION

Nowadays, mobile phones are popular communication devices. It is very convenient that people can transmit connections to anyone with mobile phones at any place all the time. In addition, the user of a mobile phone can communicate with others even when they are in a desolate place.

However, when people are in an urgent situation and can not identify where they are, for example, when they are in a desolate place or when they lose consciousness, they can not get rescued quickly even they have a mobile phone.

In the prior art, a Global Positioning System (GPS) apparatus has been known to identify the precise location of an object. The GPS apparatus transmits a signal to a satellite, and then the satellite transmits information of the location back to the GPS apparatus. Then, the longitude and latitude representing the location is shown in the screen of the GPS apparatus.

In order to overcome the problem described above, the present invention provides a method for establishing a rescue system by integrating a positioning system with a mobile phone.

### SUMMARY OF THE INVENTION

It is therefore an object of the present invention to provide a method for establishing a rescue system by integrating a positioning system with a mobile phone.

In accordance with the present invention, the method includes steps of a) setting a database in the mobile phone, b) transmitting an emergency signal to the positioning system according to the database when the mobile phone receives an emergency command, c) identifying a location of a dispatcher when the emergency signal is received by the positioning system, and d) transmitting a rescue signal from the mobile phone to a rescue unit.

According to the rescue system of the present invention, the emergency signal includes a recorded message for asking for help, the database includes the recorded message for asking for help and a phone number of the rescue unit, and the rescue signal includes the recorded signal for asking for help.

Preferably, the positioning system is Global Positioning System (GPS). The positioning system further includes a satellite for receiving the emergency signal transmitted from the mobile phone. In addition, the satellite identifies the location of the dispatcher using the mobile phone, when the satellite receives the emergency signal transmitted from the mobile phone. The location is represented by the longitude and latitude.

In accordance with an aspect of the present invention, the rescue signal includes the location of the dispatcher. The location is provided to the rescue unit to leave therefor.

In accordance with another aspect of the present invention, the emergency command can be activated by pushing a button of the mobile phone when the dispatcher is conscious. Certainly, the emergency command can also be activated by a pacemaker carried with a cardiac who loses consciousness.

The present invention may best be understood through the following descriptions with reference to the accompanying drawings, in which:

### BRIEF DESCRIPTION OF THE DRAWING

FIG. 1 is a schematic view showing the performing process of the rescue system according to the preferred embodiment of the present invention.

### DETAILED DESCRIPTION OF THE PREFERRED EMBODIMENTS

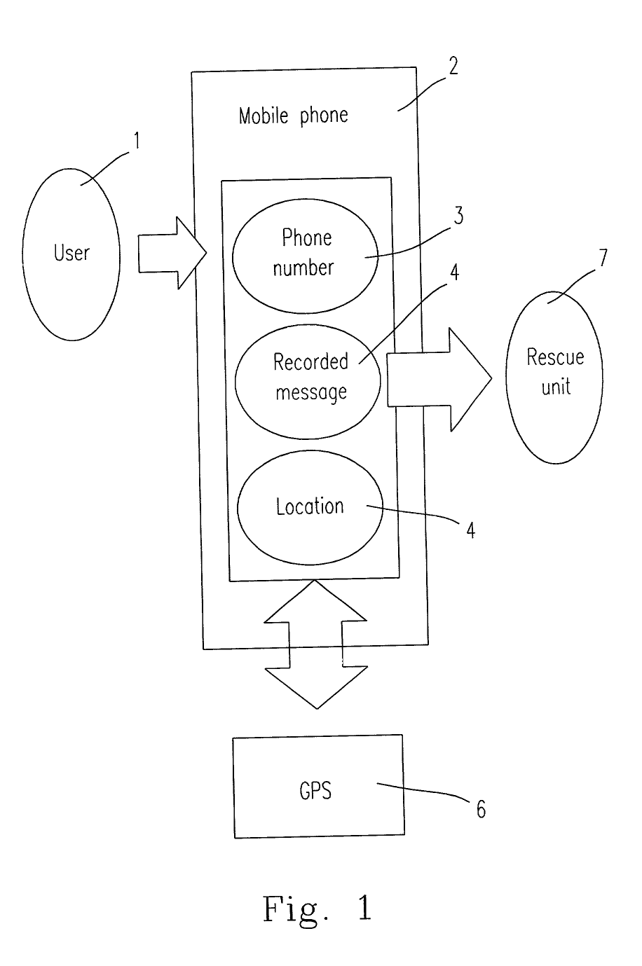

Referring to FIG. 1, the user 1 sets a database in the mobile phone 2 beforehand. The database includes a recorded message 4 for asking for help and a phone number 3 of the rescue unit 7.

When the user 1 in an urgent situation, he could push a button of the mobile phone 2 to activate the emergency command. Then, the phone number 3 of the rescue unit 7 is dialed automatically and the emergency signal is transmitted to the rescue unit 7. The emergency signal includes the recorded message 4 for asking for help and the present location 5 of the user 1 identified by the satellite of Global Positioning System 6. According to the longitude and latitude representing the location of the user 1, the rescue unit 7 could leave for the destination to help the user 1 immediately.

When the user 1 is in a certain situation, the mobile phone 2 receives an emergency command. If the user 1 loses his conscious in the certain urgent situation, the rescue system is activated by an additional device. For example, for a cardiac, the pacemaker could be coupled with a transmitter (not shown). Therefore, when the disease is broken out, the transmitter will emit a signal to the mobile phone 2 to activate the rescue system.

The method provided by the present invention is adapted to help those who can not identify where they are or who are seriously ill by transmitting an emergency signal including the location of the user to the secure unit. Thus, they could get rescued quickly.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A method for establishing a rescue system communicated with a positioning system in an urgent situation in a mobile phone, comprising steps of:
a) setting a database in said mobile phone;
b) transmitting an emergency signal to said positioning system according to said database when said mobile phone receives an emergency command;
c) identifying a location of a dispatcher when said emergency signal is received by said positioning system; and
d) transmitting a rescue signal to a rescue unit.

2. The method according to claim 1, wherein said emergency signal includes a recorded message for asking for help.

3. The method according to claim 2, wherein said database includes said recorded message for asking for help and a phone number of said rescue unit.

4. The method according to claim 2, wherein said rescue signal includes said recorded signal for asking for help.

5. The method according to claim 1, wherein said positioning system is Global Positioning System (GPS).

6. The method according to claim 1, wherein said positioning system further comprises a satellite for receiving said emergency signal transmitted from said mobile phone.

7. The method according to claim 6, wherein said satellite identifies said location of said dispatcher using said mobile phone, when said satellite receives said emergency signal transmitted from said mobile phone.

8. The method according to claim 1, wherein said location is represented by longitude and latitude.

9. The method according to claim 1, wherein said rescue signal includes said location of said dispatcher.

10. The method according to claim 1, wherein said location is provided to said rescue unit to leave therefor.

11. The method according to claim 1, wherein said emergency command is activated by pushing a button of said mobile phone.

12. The method according to claim 1, wherein said emergency command is activated by a pacemaker.
